(19) United States
(12) Patent Application Publication
(10) Pub. No.: US 2024/0381256 A1
(43) Pub. Date: Nov. 14, 2024

(54) SINGLE FREQUENCY NETWORK FOR WAKE-UP SIGNALS

(71) Applicant: Apple Inc., Cupertino, CA (US)

(72) Inventors: Sigen Ye, San Diego, CA (US); Wei Zeng, Saratoga, CA (US); Weidong Yang, San Diego, CA (US); Chunxuan Ye, San Diego, CA (US); Hong He, San Jose, CA (US); Dawei Zhang, Saratoga, CA (US)

(21) Appl. No.: 18/653,298

(22) Filed: May 2, 2024

Related U.S. Application Data
(60) Provisional application No. 63/501,701, filed on May 12, 2023.

(51) Int. Cl. H04W 52/02

(52) U.S. Cl. CPC H04W 52/0229; H04W 52/0216

(57) ABSTRACT

Systems, methods, processors, and circuitries are provided for configuring, transmitting, receiving and processing single frequency network wake-up signals. In one example a user equipment (UE) includes a radio frequency (RF) transceiver and a baseband processor. The baseband processor is configured to, when executing instructions stored in a memory, cause the UE to receive, via the RF transceiver, a wake-up signal (WUS). The WUS is transmitted by a plurality of cells in a WUS single frequency network (SFN) and each cell of the plurality of cells transmits the WUS in identical time and frequency resources. Based on the received WUS, the baseband processor causes the UE to configure one or more components of the UE to receive a subsequent signal.

### CROSS-REFERENCE TO RELATED APPLICATIONS

This application claims the benefit of priority from U.S. Provisional Patent Application Ser. No. 63/501,701 filed on May 12, 2023 entitled SINGLE FREQUENCY NETWORK FOR WAKE-UP SIGNALS, the disclosure of which is incorporated herein by reference it its entirety.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) and network devices, such as base stations, to communicate with one another. A feature of such networks and devices may include power saving measures in which a UE operates in a low power state until notified by the network of impending downlink communication.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1A is a block diagram of an example UE that includes a primary receiver and a low power receiver, according to various aspects disclosed herein.

FIG. 1B is a timeline diagram of a UE operating in a power saving mode, according to various aspects disclosed herein.

FIG. 2 illustrates an example wake-up signal (WUS), according to various aspects disclosed herein.

FIG. 3 illustrates single frequency networks (SFNs) and network areas for transmitting SFN WUS, according to various aspects disclosed herein.

FIG. 4 is a message flow diagram illustrating messaging used to support SFN WUS, according to various aspects disclosed herein.

FIG. 5 is a flow diagram outlining an example method for processing a WUS, according to various aspects described.

FIG. 6 is a flow diagram outlining an example method for transmitting a WUS, according to various aspects described.

FIG. 7 is a flow diagram outlining an example method for configuring a WUS, according to various aspects described.

FIG. 8 is a diagram of an example wireless network, according to various aspects described.

FIG. 9 is a diagram of an example of components of a device according to one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

A UE operating within a wireless network may be in one of a number of states. For example, radio resource control (RRC)-CONNECTED state refers to a state where the UE and the base station are connected and the UE is available for exchanging information with the base station. RRC-IDLE refers to a state in which the UE is not exchanging information with a base station, but the UE takes steps to find and maintain a service connection with the base station. RRC-INACTIVE refers to a state where a UE remains connected with an Access Management Function (AMF) and can move within an area configured by the network without notifying the network.

When the UE is in the RRC-IDLE or RRC-INACTIVE state, the UE may enter a sleep state in which selected UE components (e.g., a baseband processor, primary receiver, and so on) are powered off or put into a low power consumption mode to conserve power. While in the sleep state, the UE may monitor for wake-up signals (WUS) that alert the UE that it should change its operating mode to enable the UE to receive a subsequent signal. The subsequent signal may be, for example, a physical downlink control channel (PDCCH) transmission indicating that a communication will be transmitted to the UE, a reference signal for cell selection or tracking purposes, system information, and so on. Upon receiving a WUS, the components powered off during sleep may be powered back on to receive the subsequent signal.

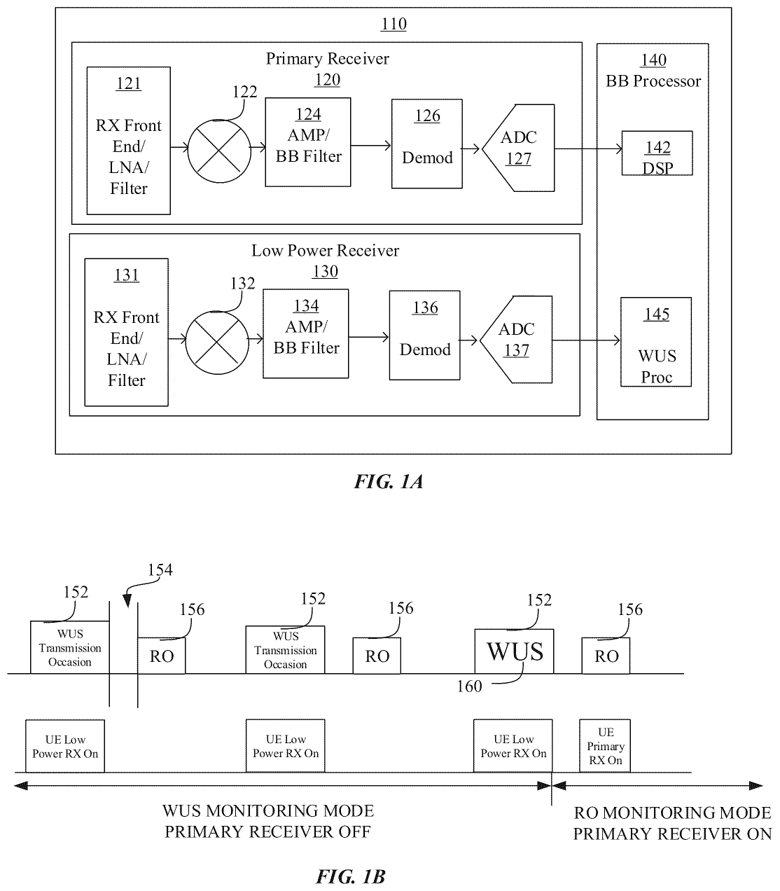

FIG. 1A is a block diagram of an example UE 110 that includes a primary receiver 120, a low power receiver 130, and a baseband processor 140. The primary receiver 120 includes a receiver front end 121, a downconverter 122, an amplifier/baseband filter 124, a demodulator 126, and an analog-to-digital convertor 127. The front end 121 may include a filter and/or a low noise amplifier (LNA) configured to receive an RF signal and amplify the received RF signal for further processing. The downconverter 122 may include circuitry configured to receive the output of the front end 121 and downconvert the RF signal using a local oscillator (LO) signal to either an intermediate frequency (IF) or to a baseband or near-baseband signal for further processing. The demodulator 126 may be configured to demodulate the received signal to recover the encoded information signal (e.g., data or payload). The ADC may be configured to convert the analog signal from the demodulator to digital signals. The output of the ADC 127 is provided to the baseband processor 140 for further processing.

The low power receiver 130 (also referred in some contexts as a WUS receiver) includes a receiver front end 131, a downconverter 132, an amplifier/baseband filter 134, a demodulator 136, and an analog-to-digital convertor 137. The front end 131 may include a filter and/or a low noise amplifier (LNA) configured to receive a WUS signal and amplify the received WUS signal for further processing. The downconverter 132 may include circuitry configured to receive the output of the front end 131 and downconvert the RF signal using a local oscillator (LO) signal to either an intermediate frequency (IF) or to a baseband or near-baseband signal for further processing. The demodulator 136 may be configured to demodulate the received signal to recover the encoded information signal (e.g., a wake-up message or information bits). The ADC may be configured to convert the analog signal from the demodulator to digital signals. The output of the ADC 137 is provided to the baseband processor 140 for further processing. It is noted that the architecture of the low power receiver 130 is just one example, and there may be other low power receiver architectures capable of utilizing the disclosed solutions.

The baseband processor includes a digital signal processor (DSP) 142 and a wake-up signal (WUS) processor 145. The DSP 142 is configured to perform one or more digital processing operations to convert the digital information signal received fro the ADC 127 to a usable data signal. The WUS processor 145 is configured to perform one or more digital processing operations to convert the digital information signal received from the ADC 137 to a signal that may be used to determine whether the primary receiver 120 and parts of the baseband processor 140 not used for WUS processing should be activated to process subsequently received signals (e.g., PDCCH, reference signals, system information, and so on).

In some examples, the low power receiver 130 may be implemented as a separate receiver from the primary receiver 120 (e.g., using a self-contained set of hardware components) as illustrated in FIG. 1A. In other examples, the low power receiver may include a portion of the primary receiver with processing capability tailored to process WUS. Accordingly, the low power receiver 130 may be efficient from a power consumption perspective because it need only process a relatively small WUS payload size (e.g., having a single bit or a few bits) and/or a simple waveform. Further, because the WUS payload size may be small, the portion of the baseband processor resources used to process the WUS (e.g., the WUS processor 145) may be small compared to the overall processing capability of the baseband processor 140 and/or the DSP 142.

FIG. 1B illustrates a timeline overview of operational status of a UE that monitors for WUS using a low power receiver. The UE is configured to monitor time and frequency resources corresponding to WUS transmission occasions 152. A number of receive opportunities (ROs) 156 are indicated in FIG. 1B. An RO is a general term for time and frequency resources allocated for paging (i.e., a paging occasion), PDCCH, reference signals, system information blocks, or any other communication that the UE should power up the primary receiver 120 to receive. The respective transmission occasions 152 are configured to precede a respective receive opportunity RO 156 by a gap 154. The gap 154 has a duration that is selected based on a time it takes for the primary receiver 120 to power on and be able to receive the expected subsequent signaling (e.g., PDCCH, reference signals, system information blocks, and so on). While the UE is in WUS monitoring mode, the primary receiver 120 and, as disclosed above, significant portions of the baseband processor are powered off or are in a very low power state. The UE low power receiver 130 is powered on to monitor each WUS transmission occasion 152. If no WUS is detected, the low power receiver may be powered down until the next WUS transmission occasion 152.

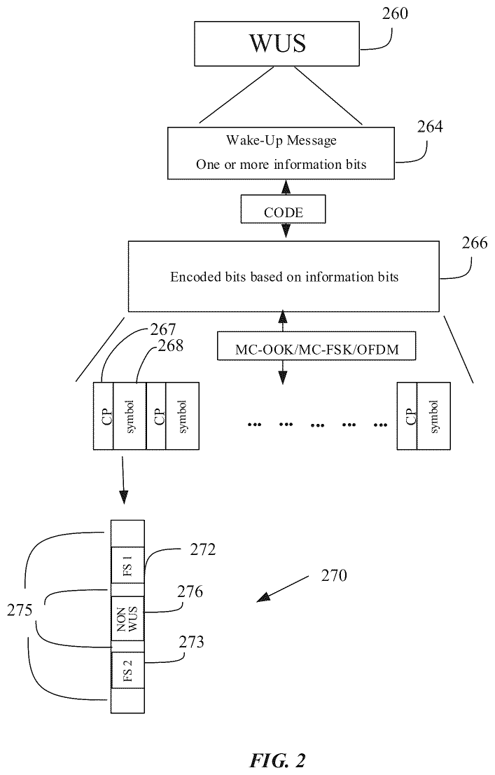

FIG. 2 illustrates an example of a WUS 260. The WUS 260 includes one or more information bits corresponding to a wake-up message. The information bits may be coded (e.g., repetition, block code, and so on) to generate encoded bits 266. The sequence of encoded bits is modulated onto symbols. For example, the encoded bits may be modulated into a sequence of orthogonal frequency division multiplexing (OFDM) symbols, with each OFDM symbol including a cyclic prefix portion 267 and a symbol portion 268. To simplify the processing necessary to decode the WUS, on-off keying (OOK) modulation may be used. In OOK modulation, for each encoded bit, to communicate a value of zero no transmission is made on subcarrier(s) allocated to the WUS during the symbol portion 268 and to communicate a value of one, some signal is transmitted on the subcarriers allocated to the WUS during the symbol portion 268. This simplifies decoding because the receiver does not need to determine which particular signal is being transmitted but only whether any signal is being transmitted on the subcarriers allocated to the WUS (e.g., a certain level of energy is detected during the symbol portion 268).

In some examples, to support frequency diversity for WUS, each symbol portion 268 includes multiple frequency segments for transmission of WUS (two frequency segments 272, 273 are shown in the illustrated example). The frequency segments include different sets of contiguous subcarriers. If the WUS is multiplexed with other signals in the frequency domain in the same OFDM symbol, to reduce interference between the WUS and other signals (e.g., signal 276) carried by the symbol, guard bands 275 (sets of contiguous subcarriers) may be included in the WUS configuration. To facilitate reception of WUS having multiple signal components carried by the multiple frequency segments, the low power receiver front end may include a filter for each frequency segment configured to filter out signals having frequencies surrounding the frequency segment. For the purposes of this disclosure a frequency segment carries a respective signal component of a WUS.

Returning to FIG. 1B, when a WUS 160 is detected during a WUS transmission occasion 152, the UE enters an RO monitoring mode and attempts to receive and decode a signal that is received during a subsequent RO 156. In the RO monitoring mode, the UE configures its components to receive signaling in a subsequent RO 156. In some examples, configuring components to receive signaling includes waking up the primary receiver 120. In some examples, while in RO monitoring mode sufficient, but not full, additional receiving and processing capabilities (as compared to WUS monitoring mode) are enabled in the UE while not all components necessary for normal RRC-CONNECTED mode operation are powered on. Any of these scenarios, in which additional components are powered on or processing power is increased as compared to during WUS monitoring mode, may be referred to herein as “waking up the primary receiver” or “operating in RO monitoring mode”.

In this manner, significant portions of the baseband processor 140 may be powered down or placed in a power saving state when the WUS processor 145 is monitoring for WUS. This may result in significant power savings and extended battery life especially for a UE that receives downlink (DL) communication only occasionally.

WUS may be designed to improve the likelihood that a low power receiver is able to detect and decode the WUS. For example, the WUS should be relatively simple and exhibit resistance to time or frequency impairments to allow lower performance RF components and simple baseband processing to be used. However, due to the reduced reception capabilities of low power receivers, WUS may be susceptible to reduced coverage as compared to non-WUS signals that will be received using the primary receiver.

### Single Frequency Network WUS

WUS may be designed to improve the likelihood that a low power receiver is able to detect and decode the WUS. For example, the WUS should be relatively simple and exhibit resistance to time or frequency impairments to allow lower performance RF components and simple baseband processing to be used. However, due to the reduced reception capabilities of low power receivers, WUS may be susceptible to reduced coverage as compared to non-WUS signals that will be received using the primary receiver. Disclosed herein are systems, processors, and methods for using a plurality of cells in a single frequency network (SFN) to transmit WUS in identical time and frequency resources. This increases the strength of the WUS that reaches the UE.

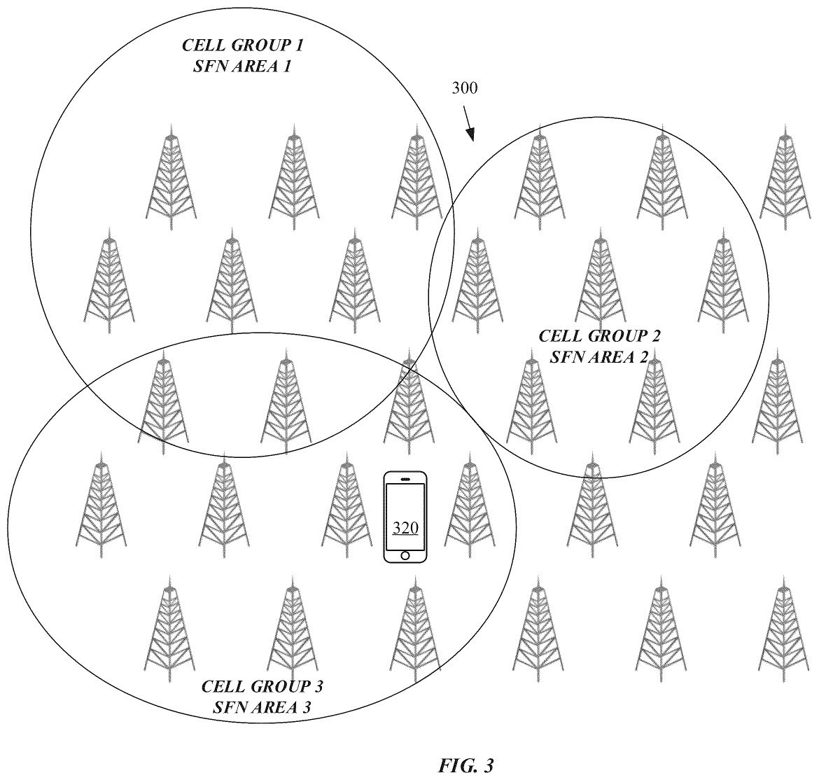

FIG. 3 illustrates the concept of SFNs, each SFN including a group of cells covering an SFN area. Typically, neighboring cells transmit different signals for the same time and frequency resources, and thus a UE 320 needs to be able to detect or decode the wanted signal under the interference from other cells. One way to improve the coverage of a signal is to have multiple neighboring cells transmitting the same signal simultaneously so the signals combine, rather than interfere, at the UE 320. This concept may be applied to WUS.

SFNs are suitable for WUS because, since the network may not know the precise location of the UE, the WUS will likely be transmitted by multiple cells. If multiple cells transmit the WUS in the same time and frequency resources, the UE will receive a stronger WUS and less interference. This leads to a higher signal to interference and noise ratio (SINR) and coverage of the WUS may be greatly improved.

The wireless network may configure SFNs for a UE or group of UEs. Different SFNs may or may not include common cells. A cell that is common to multiple SFNs would transmit the WUS for each SFN in the corresponding (different) time and frequency resources. SFNs that do not have any cells in common may use the same time and frequency resources for transmitting WUS. The SFN areas and corresponding cell groups for each SFN may be fixed or dynamically determined based, for example, on a tracking area used for paging for the one or more UEs, a radio access network (RAN)-based notification area of the one or more UEs, or a geographic area surrounding the one or more UEs.

The WUS may include an indication of an SFN ID. The SFN ID may be carried as part of the WUS payload, embedded in the WUS via scrambling or a sequence selection based on SFN ID.

One issue associated with SFN WUS is the potentially increased delay spread compared to single-cell transmission. The WUS design should compensate for delay spread if possible. One solution is to use a longer cyclic prefix (CP) portion (e.g., 267 of FIG. 2). This approach may be beneficial when the WUS includes OFDM modulated symbols and the low power receiver uses OFDM demodulation for signal detection, because the longer CP protects against a longer delay spread with OFDM demodulation. For example, the CP may be longer than a legacy CP configured for non-SFN transmission. If the WUS includes OOK or FSK modulated symbols that are to be detected with an OOK-based or frequency-shift-keying (FSK)-based receiver, another solution is to add guard time between the OOK or FSK symbols in the WUS. This will mitigate inter-symbol interference. The guard time should be selected to cover an expected delay spread of signals transmitted by the cells in the SFN.

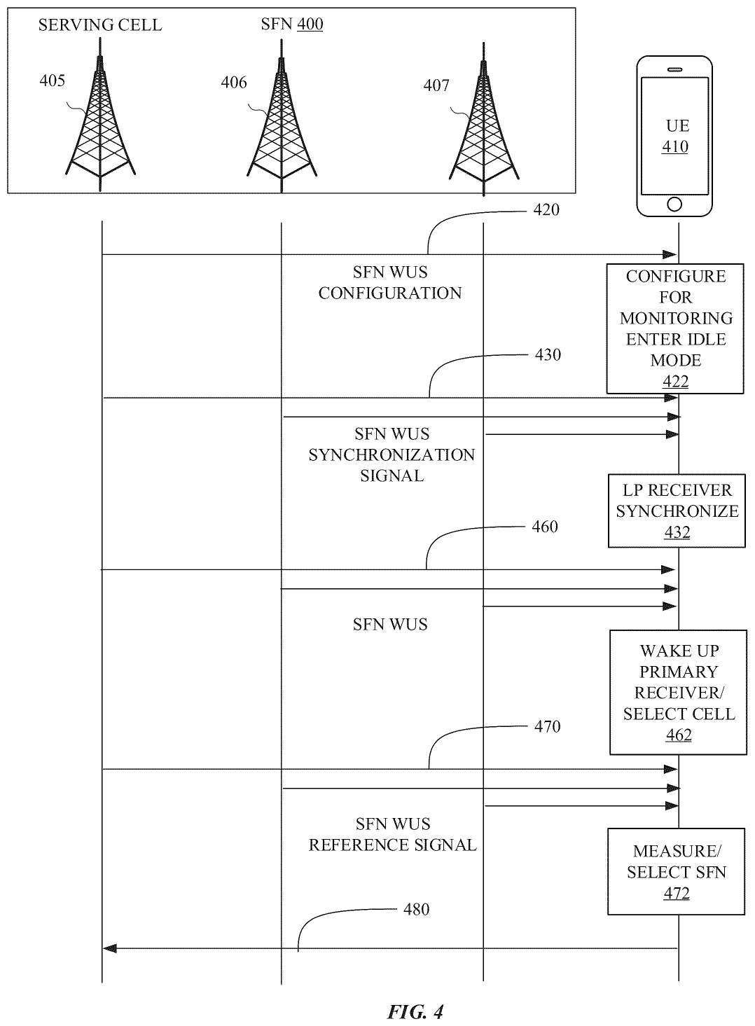

FIG. 4 is a message flow diagram outlining example signaling that may be performed by a UE 410 that is monitoring for a WUS and base stations 405, 406, 407, each providing a cell within an SFN. Prior to entering or during RRC-IDLE mode, a serving cell (e.g., base station 405) of the UE transmits a higher layer SFN WUS configuration 420 to the UE. The configuration 420 indicates one or more of time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs. The SFN WUS configuration 420 may be broadcast in each cell of the SFN, for example, via a system information message. The SFN configuration 420 may also be configured for a UE using dedicated RRC signaling. In response to the SFN WUS configuration 420 the UE configures for WUS monitoring using a low power receiver and enters RRC-IDLE mode at 422.

To assist the time and/or frequency synchronization of the low power receiver of the UE, the base stations 405,406,407 transmit an SFN WUS synchronization signal 430 that may be received by the low power receiver. The SFN WUS synchronization signal may be transmitted in a periodic and/or aperiodic manner. The SFN WUS synchronization signal may be transmitted in separately configured transmission occasions (different from the WUS transmission occasions) or just prior to the WUS transmission occasion. The SFN WUS synchronization signal may include the SFN ID. At 432 the low power receiver of the UE processes the SFN WUS synchronization signal 430 to achieve synchronization for receiving WUS.

The plurality of base stations transmit an SFN WUS 460. In response, the UE 410 wakes up the primary receiver and selects a cell to connect to for receiving the subsequent signal. The UE 410 may have moved to a different location within the SFN area and now be within the coverage area of a different cell within the SFN than when the UE entered RRC-IDLE mode. The UE 410 may have stored system information for the multiple cells in the current SFN provided by the network prior to the UE entering RRC-IDLE mode. After receiving the WUS, the UE may be able to determine that it is in the same cell or a different cell for which it has stored system information. However, the stored system information may be outdated due to changing network conditions while the UE was in RRC-IDLE.

In one example, upon receiving the WUS 460, the UE wakes up the primary receiver and checks current system information for its cell and, if the system information is up-to-date, connects to the cell. If the system information is not up-to-date, the UE re-acquires the system information for the current cell before connecting to the current cell. Another solution is that while monitoring the WUS, the primary receiver wakes up periodically to perform radio resource management (RRM) measurements for the serving cell and neighboring cells to select a cell to connect to in response to receiving a WUS. Alternatively the UE may decide when to wake up the primary receiver to perform RRM measurements based on some use case or operational parameters. For example, this determination may be made based on the mobility of the UE. If the UE is stationary, it may not need to make RRM measurements and if the UE is moving slowly it may wake up the primary receiver less frequently to make RRM measurements.

The UE may inform the network when it moves out of an SFN coverage area. To this end, an SFN reference signal 470 is sent to the UE periodically and/or aperiodically. The UE may measure the signal strength of the SFN WUS reference signal and when the strength falls below a threshold, transmit a message 480 notifying the network that the UE is outside the SFN area or at an edge of the SFN coverage area. The UE may also monitor SFN reference signals from neighboring SFNs. The network may provide an indication of neighboring SFNs to the UE. When the UE receives an SFN WUS reference signal of sufficient strength from a new SFN, the UE may select the new SFN for WUS monitoring. In this example, the message 480 also notifies the network of the SFN ID of the new network. In some examples, the SFN WUS reference signal 470 and the SFN WUS synchronization signal 430 are the same signal used for both synchronization and SFN selection.

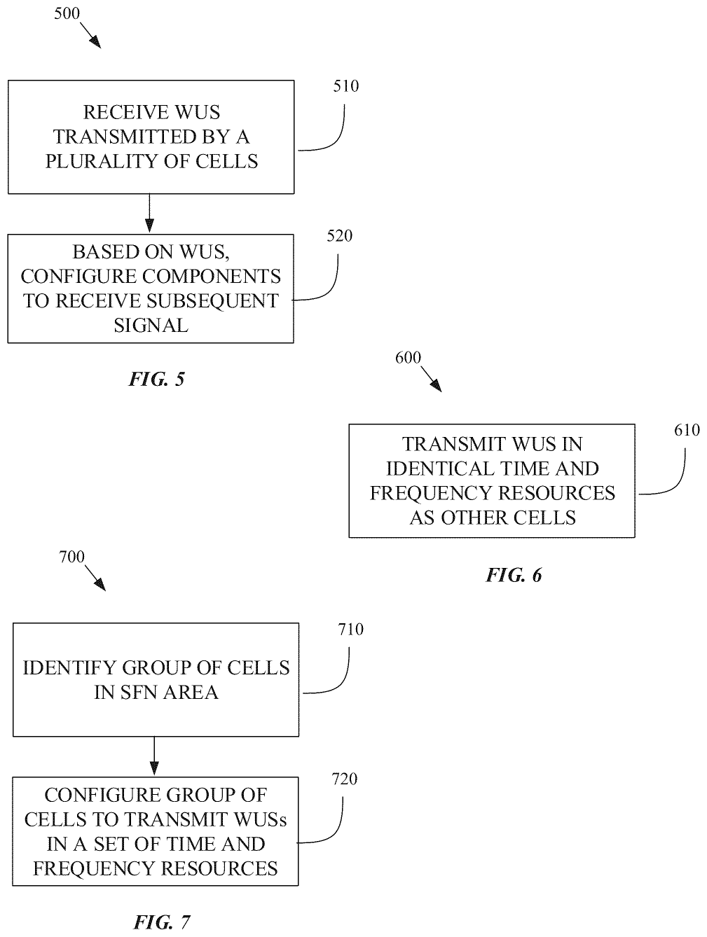

FIG. 5 is a flow diagram outlining an example method that may be performed by a UE (e.g., UE 110 of FIG. 1A and/or UE 410 of FIG. 4) to process a SFN WUS. The method includes, at 510, receiving a wake-up signal (WUS). The WUS is transmitted by a plurality of cells in a WUS single frequency network (SFN) and each cell of the plurality of cells transmits the WUS in identical time and frequency resources. At 520, the method includes configuring one or more components of the UE to receive a subsequent signal based on the received WUS.

In some examples, the WUS indicates an SFN ID in a payload of the WUS, based on scrambling of the WUS, or a sequence for the WUS selected based on the SFN ID.

In some examples, the method includes receiving an SFN WUS synchronization signal transmitted by the plurality of cells and performing time and frequency synchronization based on the SFN WUS synchronization signal (see, e.g., 430 in FIG. 4).

In some examples, a cyclic prefix (CP) of the WUS is greater than a legacy CP configured for non-SFN transmission or a duration of guard time between symbols of the WUS is selected based on an expected delay spread of signals transmitted by the plurality of cells.

In some examples, the method includes measuring an SFN WUS reference signal transmitted by the plurality of cells in the SFN and, in response to a signal strength of the SFN WUS reference signal being below a threshold, transmitting a message to a serving cell of the UE, the message indicating that the UE has moved to an edge of the SFN or out of range of the SFN (see, e.g., 470, 480 of FIG. 4). The method may include measuring SFN WUS reference signals transmitted by pluralities of cells of other SFNs; selecting an SFN based on a relative signal strength of the SFN WUS reference signals; providing an indication of the selected SFN in the message; and monitoring for WUS transmitted by cells in the selected SFN.

In some examples, the SFN WUS reference signal is the same signal as the SFN synchronization signal.

In some examples, the method includes selecting a serving cell to connect to for receiving the subsequent signal in response to receiving the WUS. The method may include, when the UE is in a different cell as compared to a cell on which the UE camped before entering a WUS monitoring mode, determining if stored system information for the different cell is up-to-date; when the stored system information is up-to-date, connect to the different cell; and when the stored system information is not up-to-date, re-acquire system information for the different cell before connecting to the different cell.

The method may include periodically performing radio resource management (RRM) measurements to select the serving cell. A rate at which RRM measurements are performed may be based on a mobility of the UE.

In some examples, the method includes monitoring for the WUS based on a received WUS configuration that indicates one or more of time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs (see, e.g., 420 of FIG. 4). The WUS configuration may be received via a broadcast message.

In some examples, the method includes receiving the WUS with a low-power receiver of the UE and powering a primary receiver of the UE to receive the subsequent signal.

In some examples, symbols of the WUS include bits mapped to a sequence carried on multiple subcarriers in one or more orthogonal frequency division multiplexing (OFDM) symbols. In some examples, symbols of the WUS are modulated with on-off keying (OOK) or frequency-shift keying (FSK).

FIG. 6 is a flow diagram outlining an example method 600 that may be performed by a base station (e.g., base station 405, 406, 407 of FIG. 4) to provide WUS to a UE. The method includes, at 610, transmitting a first wake-up signal (WUS) to a user equipment UE in a first SFN area. The first WUS is transmitted by a plurality of cells, including a cell of the base station, in the first SFN area using identical time and frequency resources.

In some examples, the method includes transmitting a second wake-up signal (WUS) to a user equipment UE in a second SFN area. The second WUS is transmitted by a plurality of cells, including a cell of the base station, in the second SFN area using identical time and frequency resources.

In some examples, the method includes transmitting a WUS configuration that indicates one or more of time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs (see, e.g., 420 of FIG. 4).

In some examples, the cyclic prefix (CP) of the WUS is greater than a legacy CP configured for non-SFN transmission or a duration of guard time between symbols of the WUS that is selected based on an expected delay spread of signals transmitted by the plurality of cells.

In some examples, the method includes providing a list of cells in the first SFN for which the UE is to store system information.

In some examples, the method includes transmitting a first SFN WUS synchronization signal, wherein the first SFN WUS synchronization signal is transmitted by a plurality of cells, including a cell of the base station, in the first SFN area using identical time and frequency resources (scc, e.g., 430 of FIG. 4). In some examples, the method includes transmitting a first SFN WUS reference signal, wherein the first SFN WUS reference signal is transmitted by a plurality of cells, including a cell of the base station, in the first SFN area using identical time and frequency resources (see, e.g., 470 of FIG. 4).

In some examples, the SFN WUS reference signal is the same signal as the SFN synchronization signal.

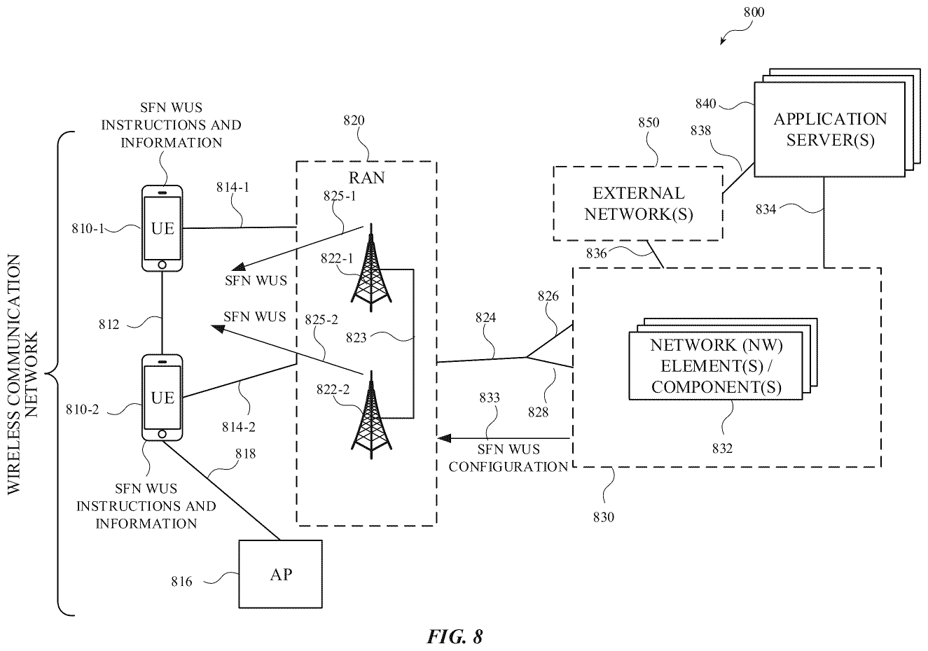

FIG. 7 is a flow diagram outlining an example method 700 that may be performed by a wireless network (e.g., NW elements/components 832 of CN 830 in FIG. 8) to configure an SFN WUS. The method includes, at 710, identifying a first group of cells located within a single frequency network (SFN) area and, at 720, configuring the first group of cells to transmit respective wake-up signals (WUS) using a first set of time and frequency resources.

In some examples, the method includes identifying a second group of cells located within a second single frequency network (SFN) area and configuring the second group of cells to transmit respective wake-up signals (WUS) using a second set of time and frequency resources. The first group and the second group may include different cells. The first group and the second group may include at least one common cell, and the time and frequency resources for the first WUS may be different from the time and frequency resources for the second WUS.

In some examples, the method includes configuring one or more of the following for the WUS: time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs.

In some examples, the cyclic prefix (CP) of the WUS is greater than a legacy CP configured for non-SFN transmission or a duration of guard time between symbols of the WUS that is selected based on an expected delay spread of signals transmitted by the first group of cells.

In some examples, the method includes selecting the first group of cells based on a tracking area for paging for a UE, a radio access network (RAN)-based notification area of the UE, or a geographic area surrounding the UE.

In some examples, the method includes configuring the first group of cells to transmit a first SFN WUS synchronization signal using identical time and frequency resources.

In some examples, the method includes configuring the first group of cells to transmit a first SFN WUS reference signal using identical time and frequency resources.

In some examples, the method includes receiving a message from a serving cell of a UE, the message indicating that the UE has moved to an edge of the SFN or out of range of the SFN (scc, e.g., 480 of FIG. 4). The message may indicate a different SFN for the UE.

As can be seen from the foregoing disclosure, an SFN WUS may improve coverage of WUS, which is especially important for UEs that include low power receivers for receiving WUS. Solutions have also been provided for synchronization, WUS signal design, and UE tracking within an SFN.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

### EXAMPLES

Example 1 is a user equipment (UE), including a radio frequency (RF) transceiver and a baseband processor, the baseband processor configured to, when executing instructions stored in a memory, cause the UE to: receive, via the RF transceiver, a wake-up signal (WUS), wherein the WUS is transmitted by a plurality of cells in a WUS single frequency network (SFN), wherein each cell of the plurality of cells transmits the WUS in identical time and frequency resources; and based on the received WUS, configure one or more components of the UE to receive a subsequent signal.

Example 2 includes the subject matter of example 1, including or omitting optional elements, wherein the WUS indicates an SFN ID in a payload of the WUS, based on scrambling of the WUS, or a sequence for the WUS selected based on the SFN ID.

Example 3 includes the subject matter of example 1, including or omitting optional elements, wherein the baseband processor is further configured to cause the UE to: receive an SFN WUS synchronization signal transmitted by the plurality of cells; and perform time and frequency synchronization based on the SFN WUS synchronization signal.

Example 4 includes the subject matter of example 1, including or omitting optional elements, wherein a cyclic prefix (CP) of the WUS is greater than a legacy CP configured for non-SFN transmission or a duration of guard time between symbols of the WUS is selected based on an expected delay spread of signals transmitted by the plurality of cells.

Example 5 includes the subject matter of example 1, including or omitting optional elements, wherein the baseband processor is further configured to cause the UE to: measure an SFN WUS reference signal transmitted by the plurality of cells in the SFN; and in response to a signal strength of the SFN WUS reference signal being below a threshold, transmit a message to a serving cell of the UE, the message indicating that the UE has moved to an edge of the SFN or out of range of the SFN.

Example 6 includes the subject matter of example 5, including or omitting optional elements, wherein the baseband processor is further configured to cause the UE to: measure SFN WUS reference signals transmitted by pluralities of cells of other SFNs; select an SFN based on a relative signal strength of the SFN WUS reference signals; provide an indication of the selected SFN in the message; and monitor for WUS transmitted by cells in the selected SFN.

Example 7 includes the subject matter of example 1, including or omitting optional elements, wherein the baseband processor is configured to cause the UE to: receive an SFN WUS synchronization signal transmitted by the plurality of cells; perform time and frequency synchronization based on the SFN WUS synchronization signal; measure the SFN WUS synchronization signal; and in response to a signal strength of the SFN WUS synchronization signal being below a threshold, transmit a message to a serving cell of the UE, the message indicating that the UE has moved to an edge of the SFN or out of range of the SFN.

Example 8 includes the subject matter of example 1, including or omitting optional elements, wherein the baseband processor is further configured to cause the UE to, in response to receiving the WUS, select a serving cell to connect to for receiving the subsequent signal.

Example 9 includes the subject matter of example 8, including or omitting optional elements, wherein the baseband processor is configured to, when the UE is in a different cell as compared to a cell on which the UE camped before entering a WUS monitoring mode, determine if stored system information for the different cell is up-to-date; when the stored system information is up-to-date, connect to the different cell; and when the stored system information is not up-to-date, re-acquire system information for the different cell before connecting to the different cell.

Example 10 includes the subject matter of example 18 including or omitting optional elements, wherein the baseband processor is configured to cause the UE to periodically perform radio resource management (RRM) measurements to select the serving cell.

Example 11 includes the subject matter of example 10, including or omitting optional elements, wherein a rate at which the baseband processor causes the UE to perform RRM measurements is based on a mobility of the UE.

Example 12 includes the subject matter of example 1, including or omitting optional elements, wherein the baseband processor is configured to cause the UE to monitor for the WUS based on a received WUS configuration that indicates one or more of time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs.

Example 13 includes the subject matter of example 12, including or omitting optional elements, wherein the baseband processor is configured to cause the UE to receive the WUS configuration via a broadcast message.

Example 14 includes the subject matter of example 1, including or omitting optional elements, wherein the baseband processor is configured to cause the UE to receive the WUS with a low-power receiver of the UE; and power a primary receiver of the UE to receive the subsequent signal.

Example 15 includes the subject matter of example 1, including or omitting optional elements, wherein symbols of the WUS include bits mapped to a sequence carried on multiple subcarriers in one or more orthogonal frequency division multiplexing (OFDM) symbols.

Example 16 includes the subject matter of example 1, including or omitting optional elements, wherein symbols of the WUS are modulated with on-off keying (OOK) or frequency-shift keying (FSK).

Example 17 is a processor of a base station, configured to cause the base station to transmit a first wake-up signal (WUS) to a user equipment UE in a first SFN area, wherein the first WUS is transmitted by a plurality of cells, including a cell of the base station, in the first SFN area using identical time and frequency resources.

Example 18 includes the subject matter of example 17, including or omitting optional elements, further configured to cause the base station to transmit a second wake-up signal (WUS) to a user equipment UE in a second SFN area, wherein the second WUS is transmitted by a plurality of cells, including a cell of the base station, in the second SFN area using identical time and frequency resources.

Example 19 includes the subject matter of example 17, including or omitting optional elements, configured to cause the base station to transmit a WUS configuration that indicates one or more of time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs.

Example 20 includes the subject matter of example 17, including or omitting optional elements, wherein a cyclic prefix (CP) of the WUS is greater than a legacy CP configured for non-SFN transmission or a duration of guard time between symbols of the WUS that is selected based on an expected delay spread of signals transmitted by the plurality of cells.

Example 21 includes the subject matter of example 17, including or omitting optional elements, configured to cause the base station to provide a list of cells in the first SFN for which the UE is to store system information.

Example 22 includes the subject matter of example 17, including or omitting optional elements, further configured to cause the base station to transmit a first SFN WUS synchronization signal, wherein the first SFN WUS synchronization signal is transmitted by a plurality of cells, including a cell of the base station, in the first SFN area using identical time and frequency resources.

Example 23 includes the subject matter of example 17, including or omitting optional elements, further configured to cause the base station to transmit a first SFN WUS reference signal, wherein the first SFN WUS reference signal is transmitted by a plurality of cells, including a cell of the base station, in the first SFN area using identical time and frequency resources.

Example 24 is a wireless communication device including memory and a processor, the processor configured to, when executing instructions stored in the memory, cause the device to: identify a first group of cells located within a single frequency network (SFN) area; and configure the first group of cells to transmit respective wake-up signals (WUS) using a first set of time and frequency resources.

Example 25 includes the subject matter of example 24, including or omitting optional elements, the processor further configured to cause the device to identify a second group of cells located within a second single frequency network (SFN) area; and configure the second group of cells to transmit respective wake-up signals (WUS) using a second set of time and frequency resources.

Example 26 includes the subject matter of example 25, including or omitting optional elements, wherein the first group and the second group include different cells.

Example 27 includes the subject matter of example 25, including or omitting optional elements, wherein when the first group and the second group include at least one common cell, time and frequency resources for the first WUS is different from the time and frequency resources for the second WUS.

Example 28 includes the subject matter of example 24, including or omitting optional elements, the processor further configured to cause the device to configure one or more of the following for the WUS: time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs.

Example 29 includes the subject matter of example 28, including or omitting optional elements, wherein a cyclic prefix (CP) of the WUS is greater than a legacy CP configured for non-SFN transmission or a duration of guard time between symbols of the WUS that is selected based on an expected delay spread of signals transmitted by the first group of cells.

Example 30 includes the subject matter of example 24, including or omitting optional elements, the processor further configured to cause the device to select the first group of cells based on a tracking area for paging for a UE, a radio access network (RAN)-based notification area of the UE, or a geographic area surrounding the UE.

Example 31 includes the subject matter of example 24, including or omitting optional elements, the processor further configured to cause the device to configure the first group of cells to transmit a first SFN WUS synchronization signal using identical time and frequency resources.

Example 32 includes the subject matter of example 24, including or omitting optional elements, the processor further configured to cause the device to configure the first group of cells to transmit a first SFN WUS reference signal using identical time and frequency resources.

Example 33 includes the subject matter of example 24, including or omitting optional elements, the processor further configured to cause the device to receive a message from a serving cell of a UE, the message indicating that the UE has moved to an edge of the SFN or out of range of the SFN.

Example 34 includes the subject matter of example 33, including or omitting optional elements, wherein the message indicates a different SFN for the UE.

Example 35 is the baseband processor of the UE of any of examples 1-16.

Example 36 is a method for a UE including operations performed by the baseband processor of any of examples 1-16.

Example 37 is a method for a base station including operations performed by the processor of any of examples 17-23.

Example 38 is an apparatus for a UE including the baseband processor, the RF transceiver, of any of examples 1-16.

Example 39 is an apparatus for a base station including the processor of any of examples 17-23.

Example 40 is a method for a wireless network device including operations performed by the processor of any of examples 24-34.

Example 41 is an apparatus for a wireless network device including the processor and memory of any of examples 24-34.

FIG. 8 is an example network 800 according to one or more implementations described herein. Example network 800 may include UEs 810-1, 810-2, etc. (referred to collectively as “UEs 810” and individually as “UE 810”), a radio access network (RAN) 820, a core network (CN) 830, application servers 840, and external networks 850.

The systems and devices of example network 800 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 800 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 810 may include smartphones (e.g., handheld touchscreen mobile computing devices connectable to one or more wireless communication networks). Additionally, or alternatively, UEs 810 may include other types of mobile or non-mobile computing devices capable of wireless communications, such as personal data assistants (PDAs), pagers, laptop computers, desktop computers, wireless handsets, watches etc. In some implementations, UEs 810 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSc) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

The connection may include an M2M connection, MTC connection, D2D connection, SL connection, etc. The connection may involve a PC5 interface. In some implementations, UEs 810 may be configured to discover one another, negotiate wireless resources between one another, and establish connections between one another, without intervention or communications involving RAN node 822 or another type of network node. In some implementations, discovery, authentication, resource negotiation, registration, etc., may involve communications with RAN node 822 or another type of network node.

UEs 810 may use one or more wireless channels 812 to communicate with one another. As described herein, UE 810-1 may communicate with RAN node 822 to request SL resources. RAN node 822 may respond to the request by providing UE 810 with a dynamic grant (DG) or configured grant (CG) regarding SL resources. A DG may involve a grant based on a grant request from UE 810. A CG may involve a resource grant without a grant request and may be based on a type of service being provided (e.g., services that have strict timing or latency requirements). UE 810 may perform a clear channel assessment (CCA) procedure based on the DG or CG, select SL resources based on the CCA procedure and the DG or CG; and communicate with another UE 810 based on the SL resources. The UE 810 may communicate with RAN node 822 using a licensed frequency band and communicate with the other UE 810 using an unlicensed frequency band.

UEs 810 may communicate and establish a connection with (e.g., be communicatively coupled) with RAN 820, which may involve one or more wireless channels 814-1 and 814-2, each of which may comprise a physical communications interface/layer.

A PQI may be determined and used to indicate a QoS associated with an SL-U communication (e.g., a channel, data flow, etc.). Similarly, an LI priority value may be determined and used to indicate a priority of an SL-U transmission, SL-U channel, SL-U data, ctc. The PQI and/or LI priority value may be mapped to a CAPC value, and the PQI, LI priority, and/or CAPC may indicate SL channel occupancy time (COT) sharing, maximum (MCOT), timing gaps for COT sharing, LBT configuration, traffic and channel priorities, and more.

As shown, UE 810 may also, or alternatively, connect to access point (AP) 816 via connection interface 818, which may include an air interface enabling UE 810 to communicatively couple with AP 816. AP 816 may comprise a wireless local area network (WLAN), WLAN node, WLAN termination point, etc. The connection 818 may comprise a local wireless connection, such as a connection consistent with any IEEE 702.11 protocol, and AP 816 may comprise a wireless fidelity (Wi-Fi®) router or other AP. While not explicitly depicted in FIG. 8, AP 816 may be connected to another network (e.g., the Internet) without connecting to RAN 820 or CN 830. The UE 810 may store SFN instructions and information for receiving and processing SFN WUS according to any of the solutions disclosed with reference to FIGS. 3-7.

RAN 820 may include one or more RAN nodes 822-1 and 822-2 (referred to collectively as RAN nodes 822, and individually as RAN node 822) that enable channels 814-1 and 814-2 to be established between UEs 810 and RAN 820. RAN nodes 822 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, cNB, 4G base station, etc.), a next generation base station (e.g., a 5G base station, NR base station, next generation eNBs (gNB), etc.). RAN nodes 822 may include a roadside unit (RSU), a transmission reception point (TRxP or TRP), and one or more other types of ground stations (e.g., terrestrial access points). In some scenarios, RAN node 822 may be a dedicated physical device, such as a macrocell base station, and/or a low power (LP) base station for providing femtocells, picocells or the like having smaller coverage areas, smaller user capacity, or higher bandwidth compared to macrocells. Additionally, or alternatively, one or more of RAN nodes 822 can be next generation eNBs (i.e., gNBs) that can provide evolved universal terrestrial radio access (E-UTRA) user plane and control plane protocol terminations 826, 828 toward UEs 810, and that can be connected to a 5G core network (5GC) 130 via an NG interface 824.

Any of the RAN nodes 822 can terminate an air interface protocol and can be the first point of contact for UEs 810. In some implementations, any of the RAN nodes 822 can fulfill various logical functions for the RAN 120 including, but not limited to, radio network controller (RNC) functions such as radio bearer management, uplink and downlink dynamic radio resource management and data packet scheduling, and mobility management. UEs 110 can be configured to communicate using orthogonal frequency-division multiplexing (OFDM) communication signals with each other or with any of the RAN nodes 822 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations are not necessarily limited in this regard. The OFDM signals can comprise a plurality of orthogonal subcarriers. As described herein, the RAN nodes 822 may be configured by an SFN WUS configuration 833 on the user or control plane 826, 828 from the CN 830 to transmit SFN WUS 825 according to any of the solutions disclosed with reference to FIGS. 3-7 to monitor for SFN WUS 825.

In some implementations, a downlink resource grid may be used for downlink transmissions from any of the RAN nodes 822 to UEs 810, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

The RAN nodes 822 may be configured to communicate with one another via interface 823. In implementations where the system is an LTE system, interface 823 may be an X2 interface. In NR systems, interface 823 may be an Xn interface. The X2 interface may be defined between two or more RAN nodes 822 (e.g., two or more eNBs/gNBs or a combination thereof) that connect to evolved packet core (EPC) or CN 830, or between two eNBs connecting to an EPC.

CN 830 may comprise a plurality of network elements 832, which are configured to offer various data and telecommunications services to customers/subscribers (e.g., users of UEs 810) who are connected to the CN 830 via the RAN 820. In some implementations, CN 830 may include an evolved packet core (EPC), a 5G CN, and/or one or more additional or alternative types of CNs. The components of the CN 830 may be implemented in one physical node or separate physical nodes including components to read and execute instructions from a machine-readable or computer-readable medium (e.g., a non-transitory machine-readable storage medium.

As shown, CN 830, application servers 840, and external networks 850 may be connected to one another via interfaces 834, 836, and 838, which may include IP network interfaces.

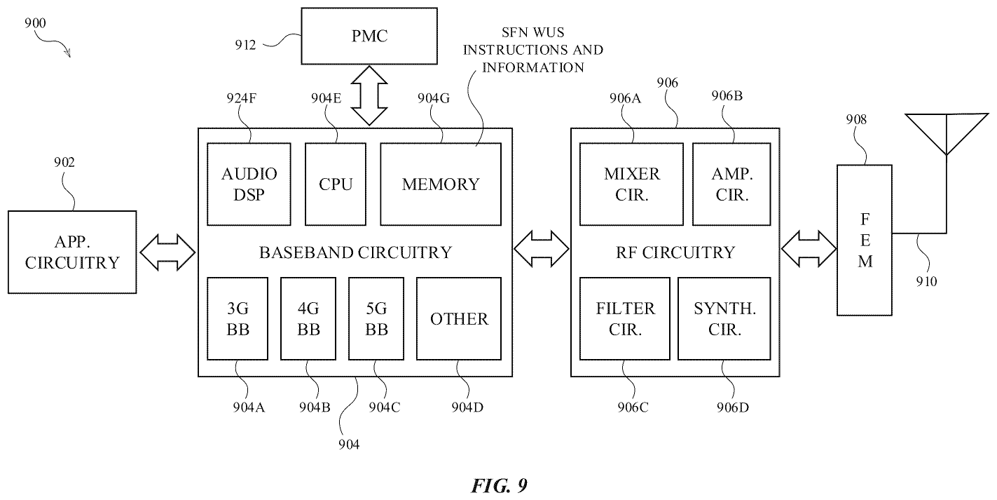

FIG. 9 is a diagram of an example of components of a wireless communication device according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a RAN node. In some implementations, the device 900 can include fewer elements (e.g., a RAN node may not utilize application circuitry 902, and instead include a processor/controller to process IP data received from a CN or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuitry 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, etc.).

The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, ctc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 904G may receive and/or store information and instructions for generating and transmitting an SFN WUS (when the device 900 is a RAN node) or receiving and processing an SFN WUS (when the device is a UE) according to any of the solutions disclosed herein.

In some implementations, the baseband circuitry 904 can include one or more audio digital signal processor(s) (DSP) 904F. The audio DSPs 904F can include elements for compression/decompression and echo cancellation and can include other suitable processing elements in other implementations.

RF circuitry 906 can embody an RF transceiver that enables communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. RF circuitry 906 can also include synthesizer circuitry 906D for synthesizing a frequency for use by the mixer circuitry 906A of the receive signal path and the transmit signal path.

The RF circuitry 906 can include analog-to-digital converter (ADC) and digital-to-analog converter (DAC) circuitry and the baseband circuitry 904 can include a digital baseband interface to communicate with the RF circuitry 906.

Synthesizer circuitry 906D of the RF circuitry 906 can include a divider, a delay-locked loop (DLL), a multiplexer and a phase accumulator.

FEM circuitry 908 can include a receive signal path which can include circuitry configured to operate on RF signals received from one or more antennas 910, amplify the received signals and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit or receive signal paths can be done solely in the RF circuitry 906, solely in the FEM circuitry 908, or in both the RF circuitry 906 and the FEM circuitry 908.

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904. However, in other implementations, the PMC 912 may be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_Connected state, where it is still connected to the RAN node as it expects to receive traffic shortly, then it can enter a state known as Discontinuous Reception Mode (DRX) after a period of inactivity. During this state, the device 900 can power down for brief intervals of time and thus save power. During these intervals the device 900 may periodically power up a low power receiver (see FIG. 1A) to monitor for a WUS.

If there is no data traffic activity for an extended period of time, then the device 900 can transition off to an RRC_Idle state, where it disconnects from the network and does not perform operations such as channel quality feedback, handover, etc. The device 900 goes into a very low power state and it performs paging where again it periodically wakes up to listen to the network and then powers down again. During these intervals the device 900 may periodically power up a low power receiver (see FIG. 1A) to monitor for a WUS. The device 900 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user equipment (UE), comprising a radio frequency (RF) transceiver and a baseband processor, the baseband processor configured to, when executing instructions stored in a memory, cause the UE to:
receive, via the RF transceiver, a wake-up signal (WUS), wherein the WUS is transmitted by a plurality of cells in a WUS single frequency network (SFN), wherein each cell of the plurality of cells transmits the WUS in identical time and frequency resources; and
based on the received WUS, configure one or more components of the UE to receive a subsequent signal.

2. The UE of claim 1, wherein
the WUS indicates an SFN ID in a payload of the WUS,
scrambling of the WUS is based on the SFN ID, or
a sequence for the WUS selected based on the SFN ID.

3. The UE of claim 1, wherein a cyclic prefix (CP) of the WUS is greater than a legacy CP configured for non-SFN transmission or a duration of guard time between symbols of the WUS is selected based on an expected delay spread of signals transmitted by the plurality of cells.

4. The UE of claim 1, wherein the baseband processor is further configured to cause the UE to:
measure an SFN WUS reference signal or an SFN WUS synchronization signal transmitted by the plurality of cells in the SFN; and
in response to a signal strength of the SFN WUS reference signal or the SFN WUS synchronization signal being below a threshold, transmit a message to a serving cell of the UE, the message indicating that the UE has moved to an edge of the SFN or out of range of the SFN.

5. The UE of claim 4, wherein the baseband processor is further configured to cause the UE to:
measure SFN WUS reference signals or synchronization signals transmitted by pluralities of cells of other SFNs;
select an SFN based on a relative signal strength of the SFN WUS reference signals or synchronization signals;
provide an indication of the selected SFN in the message; and
monitor for WUS transmitted by cells in the selected SFN.

6. The UE of claim 1 wherein the baseband processor is configured to, when the UE is in a different cell as compared to a cell on which the UE camped before entering a WUS monitoring mode,
determine if stored system information for the different cell is up-to-date;
when the stored system information is up-to-date, connect to the different cell; and
when the stored system information is not up-to-date, re-acquire system information for the different cell before connecting to the different cell.

7. The UE of claim 1, wherein a rate at which the baseband processor causes the UE to perform radio resource management (RRM) measurements is based on a mobility of the UE.

8. The UE of claim 1, wherein the baseband processor is configured to cause the UE to monitor for the WUS based on a received WUS configuration that indicates one or more of time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs.

9. The UE of claim 8, wherein the baseband processor is configured to cause the UE to receive the WUS configuration via a broadcast message.

10. A baseband processor of a base station, configured to perform operations comprising:
instructing a transceiver to transmit a first wake-up signal (WUS) to a user equipment UE in a first SFN area, wherein the first WUS is transmitted by a plurality of cells, including a cell of the base station, in the first SFN area using identical time and frequency resources.

11. The baseband processor of claim 10, wherein the operations comprise:
instructing the transceiver to transmit a second wake-up signal (WUS) to a user equipment UE in a second SFN area, wherein the second WUS is transmitted by a plurality of cells, including a cell of the base station, in the second SFN area using identical time and frequency resources.

12. The baseband processor of claim 10, wherein the operations comprise instructing the transceiver to transmit a WUS configuration that indicates one or more of time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs.

13. The baseband processor of claim 10, wherein a cyclic prefix (CP) of the WUS is greater than a legacy CP configured for non-SFN transmission or a duration of guard time between symbols of the WUS that is selected based on an expected delay spread of signals transmitted by the plurality of cells.

14. The processor of claim 10, wherein the operations comprise instructing the transceiver to transmit a list of cells in the first SFN for which the UE is to store system information.

15. A wireless communication device comprising memory and a processor, the processor configured to, when executing instructions stored in the memory, cause the device to:
identify a first group of cells located within a single frequency network (SFN) area; and
cause configuration of the first group of cells to transmit respective first wake-up signals (WUS) using a first set of time and frequency resources.

16. The wireless communication device of claim 15, the processor further configured to cause the device to
identify a second group of cells located within a second single frequency network (SFN) area; and
cause configuration of the second group of cells to transmit respective second WUS using a second set of time and frequency resources, different from the first set of time and frequency resources.

17. The wireless communication device of claim 16, wherein the first group and the second group include no common cells.

18. The wireless communication device of claim 16, wherein when the first group and the second group include at least one common cell, the time and frequency resources for the first WUS are different from the time and frequency resources for the second WUS.

19. The wireless communication device of claim 15, the processor further configured to cause the device to cause configuration of one or more of time and frequency resources of the WUS, time and frequency resources of an SFN synchronization signal, an SFN ID, a subcarrier spacing of the WUS, a cyclic prefix for the WUS, a guard time between symbols, or reference signals and measurement report information for the SFN and neighboring SFNs.

20. The wireless communication device of claim 15, the processor further configured to cause the device to select the first group of cells based on a tracking area for paging for a UE, a radio access network (RAN)-based notification area of the UE, or a geographic area surrounding the UE.
